(19) United States
(12) Patent Application Publication
(10) Pub. No.: US 2020/0307101 A1
(43) Pub. Date: Oct. 1, 2020

(54) SYSTEMS AND METHODS FOR DEFECT DETECTION IN THREE-DIMENSIONAL PRINTED CONSTRUCTS

(71) Applicant: Advanced Solutions Life Sciences, LLC, Louisville, KY (US)

(72) Inventors: Alex Schultz, Fort Wayne, IN (US); Jeremy Johnson, Waynesville, OH (US); Robert Eli, Tucson, AZ (US)

(73) Assignee: Advanced Solutions Life Sciences, LLC, Louisville, KY (US)

(21) Appl. No.: 16/831,243

(22) Filed: Mar. 26, 2020

Related U.S. Application Data
(60) Provisional application No. 62/826,262, filed on Mar. 29, 2019.

(51) Int. Cl. B29C 64/393; G06T 7/00

(52) U.S. Cl. CPC B29C 64/393; B33Y 50/02; G06T 7/0004

(57) ABSTRACT

According to one or more embodiments, a system for detecting defects in a printed construct includes one or more processors, one or more image sensors, and one or more memory modules. The one or more image sensors are communicatively coupled to the one or more processors. Machine readable instructions are stored on the one or more memory modules that, when executed by the one or more processors, cause the system to collect image data of a three-dimensional printed construct from the one or more image sensors, and detect one or more defects within the image data of the three-dimensional printed construct.

### CROSS-REFERENCE TO RELATED APPLICATIONS

The present application claims the benefit of U.S. Provisional Patent Application No. 62/826,262, entitled “Defect detection in 3D Printed Constructs,” filed Mar. 29, 2019, the entirety of which is hereby incorporated by reference.

### TECHNICAL FIELD

The present specification generally relates to defect detection in three-dimensional printed constructs and, more specifically, defect detection in three-dimensional printed biologic structures/constructs.

### BACKGROUND

Tissue constructs and structures may be printed using a three-dimensional printer such as a BioAssemblyBot®. However, during printing, defects may occur. Such defects may be difficult to discern during printing or may not become apparent until after a print job is complete. This may lead to production inefficiencies.

Accordingly, a need exists for alternative systems and method for the detection of defects within three-dimensional printed biologic constructs/structures.

### SUMMARY

In one embodiment, a system for detecting defects in three-dimensional printed constructs includes one or more processors, one or more image sensors communicatively coupled to the one or more processors, and one or more memory modules communicatively coupled to the one or more processors. Machine readable instructions are stored on the one or more memory modules that, when executed by the one or more processors, cause the system to collect image data of a three-dimensional printed construct from the one or more image sensors, and detect one or more defects within the image data of the three-dimensional printed construct.

In another embodiment, a system for detecting defects in three-dimensional printed constructs includes one or more processors, a three-dimensional printer including an enclosure, one or more image sensors positioned within the enclosure and communicatively coupled to the one or more processors, and one or more memory modules communicatively coupled to the one or more processors. Machine readable instructions are stored on the one or more memory modules that, when executed by the one or more processors, cause the system to collect image data of a three-dimensional printed construct from the one or more image sensors, and detect one or more defects within the image data of the three-dimensional printed construct.

In yet another embodiment, a method for detecting defects in three-dimensional printed constructs includes receiving image data of a three-dimensional printed construct from one or more image sensors, and processing the image data with one or more processors to detect one or more defects within the image data of the three-dimensional printed construct.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a system for detecting defects in three-dimensional-printed structures/constructs, according to one or more embodiments shown and described herein;

FIG. 2 schematically depicts a print stage for printing a three-dimensional-printed structure/construct including one or more image sensors, according to one or more embodiments shown and described herein;

FIG. 3 depicts a flowchart illustrating a method of detecting defects in three-dimensional printed structures/constructs, according to one or more embodiments shown and described herein;

FIG. 4A depicts an example construct having a defect, according to one or more embodiments show and described herein;

FIG. 4B depicts another example construct having a defect, according to one or more embodiments show and described herein;

FIG. 4C depicts yet another example construct having a defect, according to one or more embodiments show and described herein;

FIG. 4D depicts one other example construct having a defect, according to one or more embodiments show and described herein; and

FIG. 4E depicts yet one more example construct having a defect, according to one or more embodiments show and described herein.

### DETAILED DESCRIPTION

Embodiments of the present disclosure are directed to systems and methods for detecting defects in three-dimensional printed constructs and/or structures. It is noted the three-dimensional printed constructs and three-dimensional printed structures may be used interchangeably through the present disclosure.

In some embodiments, defects may be detected in real time as a construct is being printed. For example, one or more image sensors may be placed in and/or around a print stage of the three-dimensional printer and be configured to obtain image data of the construct as it is printed. The image data from the one or more images sensors may be processed using machine-readable instructions that, when executed by a processor, as described in greater detail below, cause a system to perform object recognition to detect one or more defects within the three-dimensional printed construct. Upon and based on detection of one or more defects, the system may take one or more actions of, for example, notifying a user, adjusting operating parameters of the three-dimensional printer, aborting the print job (i.e., aborting completion of the three-dimensional construct), etc.

Accordingly, print jobs may be monitored in real-time (e.g., with minimal lag time) to allow for identification of defects. Such real-time monitoring may increase printing efficiency and material use by identifying defects of a biological construct/structure as the biological construct/structure is printed, such that remedial actions can be made or a print may be aborted without additional waste. These and additional features will be discussed in greater detail below.

Biological tissue structures and constructs may be three-dimensionally printed using such devices as a BioAssemblyBot® (such as described in U.S. patent application Ser. No. 15/726,617, filed Oct. 6, 2017, entitled “System and Method for a Quick-Change Material Turret in a Robotic Fabrication and Assembly Platform,” hereby incorporated by reference in its entirety and as available from Advanced Solutions Life Sciences, LLC of Louisville, Ky.). Additionally, printed constructs and methods of fabrication are further described in U.S. patent application Ser. No. 15/202,675, filed Jul. 6, 2016, entitled “Vascularized In Vitro Perfusion Devices, Method, of Fabricating, and Applications Thereof,” hereby incorporated by reference in its entirety.

It is also noted that recitations herein of “at least one” component, element, etc., or “one or more” components, elements, etc., should not be used to create an inference that the alternative use of the articles “a” or “an” should be limited to a single component, element, etc.

It is noted that recitations herein of a component of the present disclosure being “configured” or “programmed” in a particular way, to embody a particular property, or to function in a particular manner, are structural recitations, as opposed to recitations of intended use.

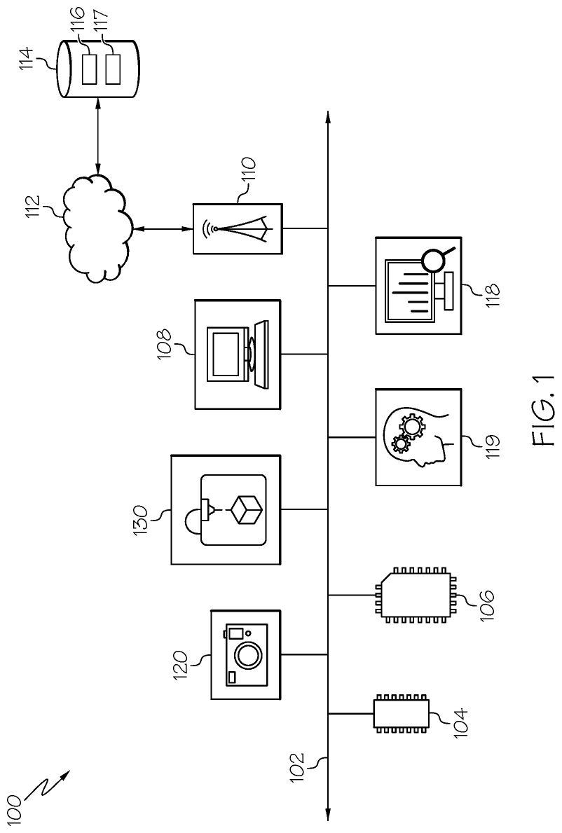

FIG. 1 depicts a system 100 for the detection of one or more defects in a three-dimensional printed construct such as a three-dimensional printed biological construct or structure. The system generally includes a communication path 102, one or more processors 104, one or more memory modules 106, and one or more image sensors 120. For performing defect detection, an image analytics module 118 and a machine-learning module 119 may also be included and communicatively coupled to the one or more processors 104. The system 100 may further include additional communicatively coupled components such as, but not limited to, a three-dimensional printer 130, one or more user interface devices 108, and/or network interface hardware 110. It is noted that a greater or fewer number of modules may be included within the system 100 without departing from the present disclosure. It is further noted that lines (e.g., communication paths 102) within FIG. 1 are intended to show communication and not necessarily physical locations or proximities of modules relative to one or another. That is, modules of the present system 100 may operate remotely from one another in a distributed computing environment.

The communication path 102 provides data interconnectivity between various modules of the system 100. Specifically, each of the modules can operate as a node that may send and/or receive data. In some embodiments, the communication path 102 includes a conductive material that permits the transmission of electrical data signals to processors, memories, sensors, and actuators throughout the system 100. The communication path 102 may be formed from any medium that is capable of transmitting a signal such as, for example, conductive wires, conductive traces, optical waveguides, or the like, or from a combination of mediums capable of transmitting signals. As used herein, the term “communicatively coupled” means that coupled components are capable of exchanging data signals with one another such as, for example, electrical signals via conductive medium, electromagnetic signals via air, optical signals via optical waveguides, and the like. Accordingly, communicatively coupled may refer to wired communications, wireless communications, and/or any combination thereof.

The one or more processors 104 may include any device capable of executing machine-readable instructions. Accordingly, the one or more processors 104 may be a controller, an integrated circuit, a microchip, a computer, or any other computing device. The one or more processors 104 are communicatively coupled to the other components of system 100 by the communication path 102. Accordingly, the communication path 102 may communicatively couple any number of processors with one another, and allow the modules coupled to the communication path 102 to operate in a distributed computing environment. Specifically, each of the modules can operate as a node that may send and/or receive data.

The one or more memory modules 106 are communicatively coupled to the one or more processors 104 over the communication path 102. The one or more memory modules 106 may be configured as non-transitory volatile and/or nonvolatile memory and, as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the system 100 and/or external to the system 100, such as within one or more remote servers 114.

Embodiments of the present disclosure include logic stored on the one or more memory modules 106 as machine-readable instructions to perform an algorithm written in any programming language of any generation (e.g., 1GL, 2GL, 3GL, 4GL, and/or 5GL) such as in machine language that may be directly executed by the one or more processors 104, assembly language, obstacle-oriented programming (OOP), scripting languages, microcode, etc., that may be compiled or assembled into machine readable instructions and stored on a machine readable medium. Similarly, the logic may be written in a hardware description language (HDL), such as logic implemented via either a field-programmable gate array (FPGA) configuration or an application-specific integrated circuit (ASIC), and their equivalents. Accordingly, the logic may be implemented in any conventional computer programming language, as pre-programmed hardware elements, and/or as a combination of hardware and software components. As will be described in greater detail herein, machine-readable instructions stored on the one or more memory modules 106 allows the one or more processors 104 to, for example, process image data to identify print defects within a printed construct. The one or more processors 104 may further execute the machine-readable instructions to, based on the identified print defect(s), alert the user, abort a print job, and/or adjust operating parameters of the three-dimensional printer 130. As noted above, the embodiments described herein may utilize a distributed computing arrangement to perform any portion of the logic described herein.

In some embodiments, the system 100 further includes an image analytics module 118 and a machine-learning module 119 for intelligently identifying defects in a three-dimensional printed construct or structure. The image analytics module 118 is configured to at least apply data analytics and artificial intelligence algorithms and models to received images, including, but not limited to, static and/or video images received from the one or more image sensors 120. The machine-learning module 119 is configured for operating with such artificial intelligence algorithms and models, such as to the image analytics module 118, to continue to improve accuracy of said algorithms and models through application of machine learning. By way of example, and not as a limitation the machine-learning module 119 may include an artificial intelligence component to train and provide machine-learning capabilities to a neural network as described herein. In an embodiment, a convolutional neural network (CNN) may be utilized. The image analytics module 118 and the machine-learning module 119 may be communicatively coupled to the communication path 102 and the one or more processors 104. As will be described in further detail below, the one or more processors 104 may, using at least the image analytics module 118 and/or the machine-learning module 119, process the input signals received from the system 100 modules and/or extract information (e.g., defect detection) from such signals.

For example, data stored and manipulated in the system 100 as described herein may be utilized by the machine-learning module 119. The machine-learning module 119 may be able to leverage a cloud computing-based network configuration such as the cloud to apply Machine Learning and Artificial Intelligence as terms of art readily understood by one of ordinary skill in the art. This machine-learning module 119 may be applied to and improve models that can be applied by the system 100, to make it more efficient and intelligent in execution. As an example and not a limitation, the machine-learning module 119 may include artificial intelligence components selected from the group consisting of an artificial intelligence engine, Bayesian inference engine, and a decision-making engine, and may have an adaptive learning engine further comprising a deep neural network-learning engine. It is contemplated and within the scope of this disclosure that the term “deep” with respect to the deep neural network learning engine is a term of art readily understood by one of ordinary skill in the art. In embodiments, to apply and improve upon a model via machine-learning, numerous print jobs may be recorded using the one or more image sensors 120 and used by the machine-learning module 119 to reduce error in the model. In an embodiment, some print jobs may include purposely-created defects. The raw footage may then be split into individual frames, which may then be annotated, e.g., by a user to indicate defects, and used to train the model of the system 100 to detect defects. Using this technique, results can be incrementally improved over time by incorporating new data into the training process for the model. However, in some embodiments, and as noted above, models 116 may be trained and stored remotely at the one or more remote servers 114.

The one or more image sensors 120 may include any sensor configured to collect and transmit image data including cameras, video recorders, or the like. The one or more image sensors 120 may be communicatively coupled to the three-dimensional printer 130.

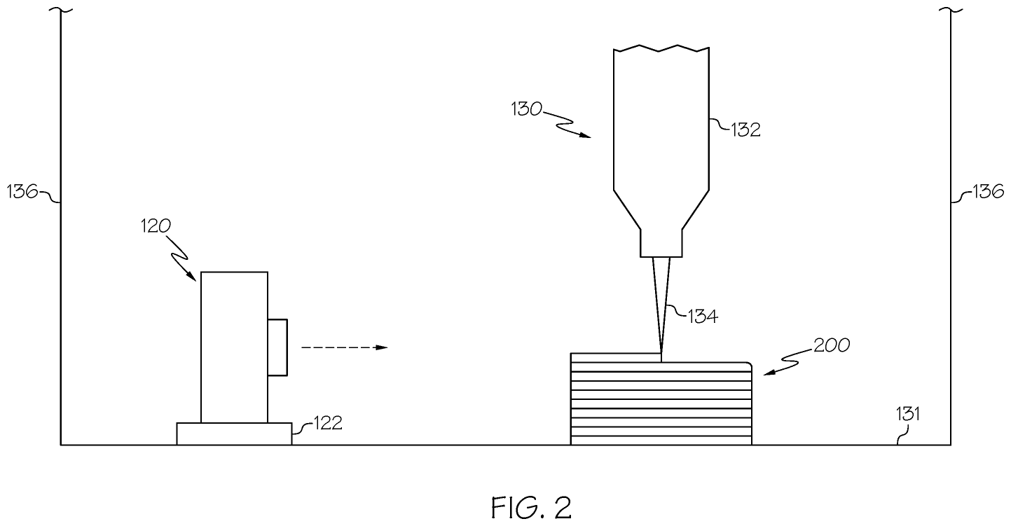

With reference to FIG. 2, a print stage 131 for an embodiment of the three-dimensional printer 130 is schematically depicted. The three-dimensional printer 130 may include a print actuator 132 including a dispensing nozzle 134 for dispensing material for forming the three-dimensional construct. The three-dimensional printer 130 may further include an enclosure 136. The one or more image sensors 120 may be mounted relative to the print stage 131 so as to capture image data of the three-dimensional construct being printed. For example, the one or more image sensors 120 may be mounted, e.g., via a mounting bracket 122, within the enclosure 136 of the print stage 131. In some embodiments, it is contemplated that one or more image sensors 120 may be mounted to the print actuator 132 and/or the dispensing nozzle 134. It is noted that though only one image sensor is depicted, additional image sensors (e.g., 2 or more, 3 or more, 4, or more, etc.) may be included so as to capture various aspects or angles of the three-dimensional printed construct 200 while it is being printed.

Referring again to FIG. 1, the three-dimensional printer 130 is communicatively coupled to the one or more processors 104 over the communication path 102. As will be described in greater detail herein, the one or more processors 104 may execute machine-readable instructions to control operation of the three-dimensional printer 130. For example, the one or more processors 104 may execute machine-readable instructions such that the system 100 can adjust operating parameters (e.g., speed, pressure, adjusting layer deposition to correct a defect) of the three-dimensional printer 130, and/or abort a print job, in response to detecting one or more defects.

One or more user interface devices 108 may include any computing device(s) that allows a user to interact with the system 100. For example, the one or more user interface devices 108 may include any number of displays, touch screen displays, and input devices (e.g., buttons, toggles, knobs, keyboards, microphones, etc.) which allow interaction and exchange of information between the user and the system 100. In some embodiments, the one or more user interface devices 108 may include a mobile user device, (e.g., a smartphone, pager, tablet, laptop, or the like). Using the one or more user interface devices 108 a user may communicate preferences and/or instructions for action by the system, as will be described further below.

Still referring to FIG. 1, the system 100 may further include network interface hardware 110. The network interface hardware 110 may be communicatively coupled to the one or more processors 104 over the communication path 102. The network interface hardware 110 may communicatively couple the system 100 with a network 112 (e.g., a cloud network). The network interface hardware 110 can be any device capable of transmitting and/or receiving data via the network 112. Accordingly, the network interface hardware 110 can include a communication transceiver for sending and/or receiving any wired or wireless communication. For example, the network interface hardware 110 may include an antenna, a modem, LAN port, Wi-Fi card, WiMax card, mobile communications hardware, near-field communication hardware, satellite communication hardware, and/or any wired or wireless hardware for communicating with or through other networks.

In embodiments, the network 112 may include one or more computer networks (e.g., a personal area network, a local area network, grid computing network, wide area network, etc.), cellular networks, satellite networks, and/or any combinations thereof. Accordingly, the system 100 can be communicatively coupled to the network 112 via a wide area network, via a local area network, via a personal area network, via a cellular network, via a satellite network, via a cloud network, or the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks include, but are not limited to, technologies such as LTE, WiMAX, UMTS, CDMA, and GSM.

As noted above, in some embodiments, one or more remote servers 114 may be communicatively coupled to the other components of the system 100 over the network 112. The one or more remote servers 114 may generally include any number of processors, memories, and chipsets for delivering resources via the network 112. Resources can include providing, for example, processing, storage, software, and information from the one or more remote servers 114 to the system 100 via the network 112. Additionally, it is noted that the one or more remote servers 114 and any additional servers can share resources with one another over the network 112 such as, for example, via the wired portion of the network 112, the wireless portion of the network 112, or combinations thereof In some embodiments, training models 116 for use by the system 100, may be stored on the one or more remote servers 114.

As an example, and not a limitation, in some embodiments, the one or more memory modules 106 may store defect recognition logic as applied by one or more models of the machine-learning module 119 for identifying one or more defects within a three-dimensional printed construct or structure. In some embodiments, models 116 for identifying defects may be stored on the one or more remote servers 114. In yet further embodiments, models 116 may be trained by submitting one or more training data sets (e.g., image data) to the one or more remote servers 114. With reference to the use of training or trained herein, it is to be understood that, in an embodiment, a model object is trained or configured to be trained and used for data analytics as described herein and includes a collection of training data sets based on images data (e.g., annotated photos and/or video) placed within the model object.

The one or more remote servers 114 may process the image data to generate training models 116, which may be accessed by the one or more processors 104, e.g., using the machine-learning module 119, of the system 100, to train the system 100 to identify the one or more defects within a three-dimensional printed construct 200. For example, training data sets may include image data of one or more printed constructs/structures that are annotated by a user to identify defects within the image data. The one or more remote servers 114 may include a graphics-processing unit (GPU) 117, to perform object recognition on the image data and the user annotations to identify characteristics of one or more defects to train the model to be used in the identification of one or more defects in raw image data from the one or more image sensors 120. Many sources of training data may be combined to create enhanced, more intelligent training models for improved defect detection.

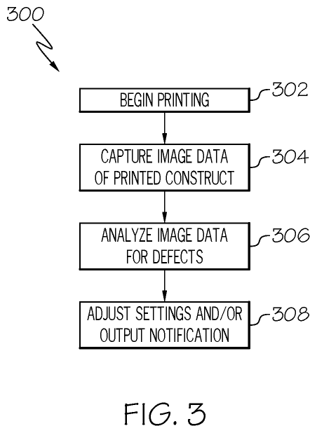

Referring now to FIG. 3, a flowchart depicting a method 300 for detecting defects in a three-dimensional printed construct is illustrated. It is noted that while a discrete number of steps are illustrated in a depicted order, additional and/or fewer steps, in any order, may be included without departing from the scope of the present disclosure.

To begin, a new print job may be started, at step 302. Step 304 includes capturing image data of a three-dimensional printed construct as it is being printed (e.g., in real time). In some embodiments, the system 100 may be automatically initiated to begin capturing and processing image data of the three-dimensional printed construct 200 as the three-dimensional printed construct 200 is printed (i.e., in real-time and/or with minimal lag time, such as less than 1 minutes, less than 45 seconds, less than 30 seconds, less than 10 seconds, etc.). At step 306, the image data may be analyzed, by the one or more processors, to detect defects within the three-dimensional printed construct 200. As noted above, the image data may be captured using the one or more image sensors 120, and analyzed by the one or more processors 104, in real time to provide feedback to user or to the system 100 of the detection of one or more defects.

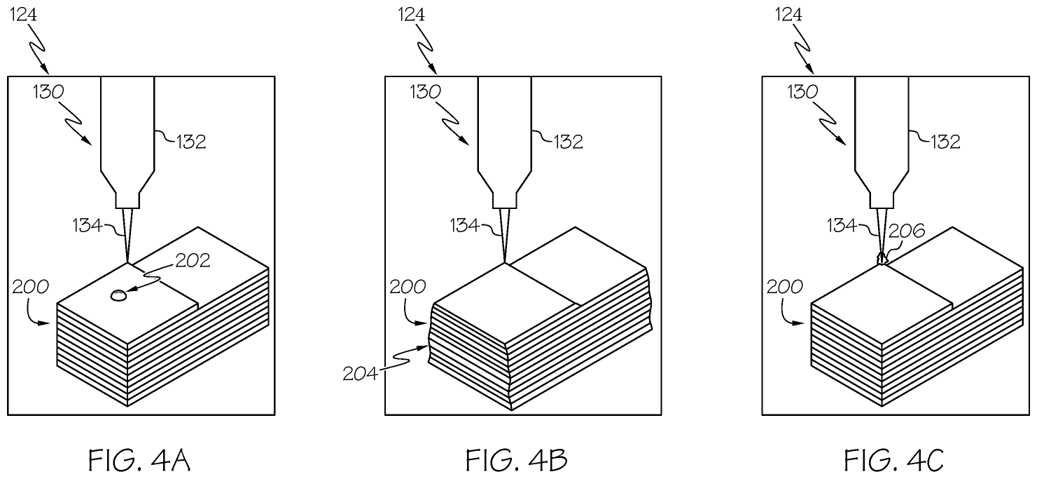

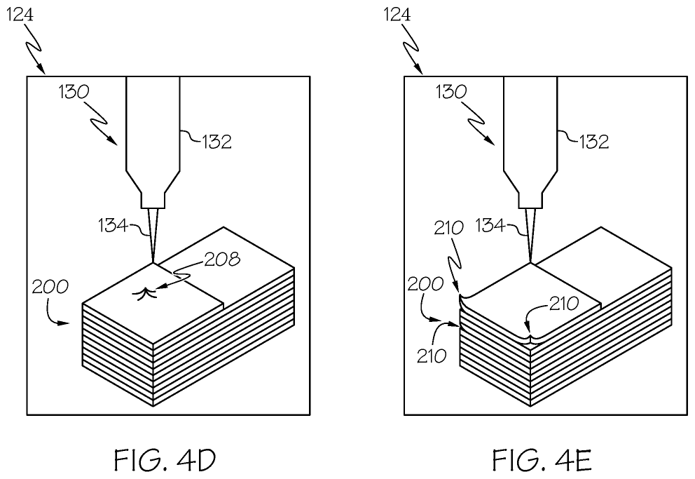

There may be multiple possible undesirable defects that may be formed and detected as described herein in a three-dimensional printed construct during printing. FIGS. 4A-4E illustrate a collection of non-limiting example image data 124 depicting some, though not all, of the possible defects, which may be identified by the system 100.

For example, FIG. 4A depicts a three-dimensional printed construct 200 with an air bubble 202 formed therein. Air bubbles may lead to inconsistent density within a construct (e.g., in the form of cavities), which may lead to collapse, crater formation, and/or effect growth of biological objects (e.g., blood vessels, cells, a-cellular structures, or the like). Air bubbles may be formed by dispensing material too quickly, and may be addressed by slowing material deposition.

FIG. 4B illustrates another three-dimensional printed construct 200 having a defect including bulging sidewalls 204. Bulging sidewalls may result from pushing too much material during printing, and or dispensing material too quickly. Bulging sidewalls may cause a biological construct or structure to deviate from desired dimensions and/or characteristics.

FIG. 4C illustrates yet another three-dimensional printed construct 200 with excess material 206 collecting on the tip of the dispensing nozzle 134. Material collecting on the tip of the dispensing nozzle 134 may lead to scraping of the dispensing nozzle 134 on the three-dimensional printed construct 200 and/or may prevent dispensing of material from the dispensing nozzle 134.

FIG. 4D illustrates another possible defect for a three-dimensional printed construct 200 that includes peaking. Peaking refers to spike 208 formed on the surface of the three-dimensional printed construct 200. Such spikes may be caused by too little pressure used in layer deposition. Peaking, as many of the other noted defects, may lead to undesirable deviations from desired characteristics of a three-dimensional printed construct.

FIG. 4E depicts one other three-dimensional printed construct 200 as including poor layer adhesion and/or layer separation 210. That is, such defect may cause individual layers of dispensed material to peel away from one another, which may cause unwanted deviations from desired characteristics (e.g., dimension, form, structural stability, or like). It is contemplated within the scope of this disclosure that one or more defects, such as the defects described herein and with respect to FIGS. 4A-4E, may be detected by the system 100.

Other types of defects are contemplated and possible. For example material curling may occur when print material is extruded into air or if a layer height is set too low. Another defect may occur by extruding material at an improper extrusion location. For example, extruding material into air as opposed to extruding onto a previous print layer or onto a print stage. Scraping, or nozzle scraping, may occur when the dispensing nozzle of the three-dimensional printer scrapes and/or gouges the three dimensional construct.

Referring again to FIG. 3, once a defect is detected and based on the detection of the defect and one or more parameters associated with the defect, including type of detect, size of defect, or other defect parameters, the system 100 may operate with the one or more processors 104 to take one or more actions, at step 308. For example, the system 100 may cause the one or more user interface devices 108 to automatically output an alert or notification to the user of the detected defect. In some embodiments, the user interface device may automatically annotate the image to highlight the detected defect and display the same to a user using a display (e.g., a graphical user interface (GUI) display) of the one or more user interface devices 108. In some embodiments, the one or user interface devices 108 may be automatically controlled to display the type of identified defect (e.g., air bubble, bulging sidewalls, scraping, poor layer adhesion, peaking, etc.). In some embodiments, the system 100 may provide or display options to the user based on the detected defect, including but not limited to “abort print job,” “continue printing,” and/or “adjust print parameters. It is noted, in some embodiments, the one or more user interface devices 108 may include a mobile user device, e.g., a smartphone, pager, tablet, laptop, or the like. In such embodiments, alerts may be issued to a user's device via transmission through the network interface hardware 110 over the network 112, in response to detecting one or more defects within the image data of the three-dimensional printed construct. Accordingly, a user may be notified when remote and away from the vicinity of the three-dimensional printer 130 and may also take actions remotely to input instructions into the system 100.

In some embodiments, depending on the type of defect detected, the system 100 may, operating with the one or more processors 104, automatically adjust operating parameters (e.g., pressure settings, speed settings, or the like) of the system 100 to fix and/or prevent further defects, with or without an alert to the user. For example, pressures may be adjustment to either increase or decrease printer pressure at which material is delivered. Such adjustments either positively or negatively may be in about 1 psi to about 2 psi (e.g., about 6.9 kPa to about 13.8 kPa) increments until the defect is no longer being produced on newly extruded material. Print speed may be adjusted to any speed at which the three dimensional printer is capable of operating (e.g., less than about 1 mm/s to about 35 mm/s). Adjustments may be made incrementally (e.g., one a scale of less than about 1 mm/s to about 5 mm/s (or about 1 mm/s to about 10 mm/s, etc.) until the defect is no longer being produced on newly extruded material. In some embodiments, defects may be corrected by adjusting the width and or height of the extruded material. For example, the adjustments to the width (e.g., line width) or height (line height) may be made incrementally (e.g., between about 0 and about 1 mm) until the defect is no longer being produced on newly extruded material.

In some embodiments, where a defect is detected, the system 100 may control the three-dimensional printer to return and repair and/or fill the defect. For example, where defects including craters and/or scrapes have been detected, the dispensing nozzle may be repositioned over the crater/scrape to fill the void.

In some embodiments, the system 100, for example where a defect cannot be corrected, may automatically abort or halt a print job, in response to detecting one or more defects.

In some embodiments, the one or more processors 104 may execute logic to distinguish between acceptable defects and unacceptable defects. For example, a user, in either the training model, or other user preference inputs received over the one or more user interface devices 108 may provide inputs to determine acceptable versus unacceptable defects. For example, the number of detected defects (1 or more, 2, or more, 5 or more, 10 or more, etc.) may be set the user before further action by the system 100, e.g., before sending an alert, adjusting print operating parameters, and/or aborting a print job). In some embodiments, a size of the defect may be used to determine acceptable versus unacceptable defects (e.g., defect greater 5 mm, 10 mm, etc.). In some embodiments, locations of the one or more defects may allow the system 100 to determine whether a defect is acceptable versus unacceptable. By way of example, and not as a limitation, a defect location along an edge of the printed construct may be acceptable, whereas a defect located toward a center of a printed construct may be unacceptable.

As noted through, the system 100 may be configured to detect defects within a three-dimensional printed construct 200 as the three-dimensional printed construct 200 is formed. That is, the one or more processors 104 may receive image data, from the one or more image sensors 120, of the three-dimensional printed construct 200 as the three-dimensional printed construct 200 is being printed. By performing defect detection in real time, remedial actions may be taken to fix a defect and/or abort a printing operation based on detection of one or more defects as described herein.

Embodiments can be described with reference to the following numbered clauses with preferred features laid out in the dependent clauses:

1. A system for detecting defects in three-dimensional printed constructs, the system comprising: one or more processors; one or more image sensors communicatively coupled to the one or more processors; one or more memory modules communicatively coupled to the one or more processors; and machine-readable instructions stored on the one or more memory modules that, when executed by the one or more processors, cause the system to: collect image data of a three-dimensional printed construct from the one or more image sensors; and detect one or more defects within the image data of the three-dimensional printed construct.

2. The system of clause 1, further comprising one or more user interface devices communicatively coupled to the one or more processors, wherein the machine readable instructions, when executed by the one or more processors, further cause the system to output an alert with the one or more user interface devices in response to detecting the one or more defects within the image data of the three-dimensional printed construct.

3. The system of any preceding clause, further comprising a three-dimensional printer communicatively coupled to the one or more processors, wherein the machine readable instructions, when executed by the one or more processors, further cause the system to adjust operating parameters of the three-dimensional printer in response to detecting the one or more defects within the image data of the three-dimensional printed construct.

4. The system of any preceding clause, further comprising a three-dimensional printer communicatively coupled to the one or more processors, wherein the machine readable instructions when executed by the one or more processors, further cause the system to abort completion of the three-dimensional printed construct based on the one or more defects detected.

5. The system of preceding clause, wherein the image data is collected in real-time as the three-dimensional printed construct is printed.

6. The system of any preceding clause, wherein the one or more defects include at least one of air bubbles, poor layer adhesion, material peaking, material collecting on a dispensing nozzle of a three-dimensional printer, nozzle scraping, material bulging, material curling, improper extrusion location, or any combination thereof

7. The system of any preceding clause, further comprising network interface hardware communicatively coupled to the one or more processors, wherein the machine readable instructions, when executed by the one or more processors, further cause the system to output an alert with the network interface hardware to a mobile user device of a user in response to detecting the one or more defects within the image data of the three-dimensional printed construct.

8. A system for detecting defects in three-dimensional printed constructs, the system comprising: one or more processors; a three-dimensional printer comprising an enclosure; one or more image sensors positioned within the enclosure and communicatively coupled to the one or more processors; one or more memory modules communicatively coupled to the one or more processors; and machine readable instructions stored on the one or more memory modules that, when executed by the one or more processors, cause the system to: collect image data of a three-dimensional printed construct from the one or more image sensors; and detect one or more defects within the image data of the three-dimensional printed construct.

9. The system of clause 8, further comprising one or more user interface devices communicatively coupled to the one or more processors, wherein the machine readable instructions, when executed by the one or more processors, further cause the system to output an alert with the one or more user interface devices in response to detecting the one or more defects within the image data of the three-dimensional printed construct.

10. The system of clause 8 or 9, wherein the machine readable instructions, when executed by the one or more processors, further cause the system to adjust operating parameters of the three-dimensional printer in response to detecting the one or more defects within the image data of the three-dimensional printed construct.

11. The system of any of clauses 8-10, wherein the machine-readable instructions when executed by the one or more processors, further cause the system to abort completion of the three-dimensional printed construct based on the one or more defects detected.

12. The system of any of clauses 8-11, wherein the image data is collected in real-time as the three-dimensional printed construct is printed.

13. The system of any of clauses 8-12, wherein the one or more defects include at least one of air bubbles, poor layer adhesion, material peaking, material collecting on a dispensing nozzle of the three-dimensional printer, nozzle scraping, material bulging, material curling, improper extrusion location, or any combination thereof

14. The system of any of clauses 8-12, further comprising network interface hardware communicatively coupled to the one or more processors, wherein the machine readable instructions, when executed by the one or more processors, further cause the system to output an alert with the network interface hardware to a mobile user device of a user in response to detecting the one or more defects within the image data of the three-dimensional printed construct.

15. A method for detecting defects in three-dimensional printed constructs, the method comprising: receiving image data of a three-dimensional printed construct from one or more image sensors; and processing the image data with one or more processors to detect one or more defects within the image data of the three-dimensional printed construct.

16. The method of clause 15, further comprising: communicating an alert via one or more user interface devices in response to detecting the one or more defects within the image data of the three-dimensional printed construct.

17. The method of clause 15 or 16, further comprising: automatically adjusting operating parameters of a three-dimensional printer in response to detecting the one or more defects within the image data of the three-dimensional printed construct.

18. The method of any of clauses 15-17, further comprising: automatically aborting completion of the three-dimensional printed construct based on the one or more defects detected.

19. The method of any of clauses 15-18, wherein image data is collected and processed in real-time printing of the three-dimensional printed construct.

20. The method of any of clauses 15-19, wherein the one or more defects include at least one of air bubbles, poor layer adhesion, material peaking, material collecting on a dispensing nozzle of a three-dimensional printer, nozzle scraping, material bulging, material curling, improper extrusion location, or any combination thereof

It should now be understood that embodiments as described herein are directed to systems and methods for detecting defects in three-dimensional printed constructs/structures and in particular to biological constructs/structures. As described above, defects may be detected in real time as structure is being printed. For example, one or more image sensors may be placed in and/or around a print stage of the three-dimensional printer. The one or more image sensors may be positioned to obtain image data of the construct as it is printed. The images data may be processed, by one or more processors, to perform object recognition to detect one or more defects within the construct. Upon detection of one or more defects, the system may take one or more actions of notifying a user, adjusting print operating parameters, aborting the print job, etc. Accordingly, print jobs may be monitored in real-time (e.g., with minimal lag time) to allow for identification of defects, without need for user to manually monitor a print job. Such may increase printing efficiency and material use by identifying defects as a biological construct/structure is printed, such that remedial actions can be made or a print may be aborted without additional waste.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for detecting defects in three-dimensional printed constructs, the system comprising:
one or more processors;
one or more image sensors communicatively coupled to the one or more processors;
one or more memory modules communicatively coupled to the one or more processors; and
machine-readable instructions stored on the one or more memory modules that, when executed by the one or more processors, cause the system to:
collect image data of a three-dimensional printed construct from the one or more image sensors; and
detect one or more defects within the image data of the three-dimensional printed construct.

2. The system of claim 1, further comprising one or more user interface devices communicatively coupled to the one or more processors, wherein the machine readable instructions, when executed by the one or more processors, further cause the system to output an alert with the one or more user interface devices in response to detecting the one or more defects within the image data of the three-dimensional printed construct.

3. The system of claim 1, further comprising a three-dimensional printer communicatively coupled to the one or more processors, wherein the machine readable instructions, when executed by the one or more processors, further cause the system to adjust operating parameters of the three-dimensional printer in response to detecting the one or more defects within the image data of the three-dimensional printed construct.

4. The system of claim 1, further comprising a three-dimensional printer communicatively coupled to the one or more processors, wherein the machine readable instructions when executed by the one or more processors, further cause the system to abort completion of the three-dimensional printed construct based on the one or more defects detected.

5. The system of claim 1, wherein the image data is collected in real time as the three-dimensional printed construct is printed.

6. The system of claim 1, wherein the one or more defects include at least one of air bubbles, poor layer adhesion, material peaking, material collecting on a dispensing nozzle of a three-dimensional printer, nozzle scraping, material bulging, material curling, improper extrusion location, or any combination thereof

7. The system of claim 1, further comprising network interface hardware communicatively coupled to the one or more processors, wherein the machine readable instructions, when executed by the one or more processors, further cause the system to output an alert with the network interface hardware to a mobile user device of a user in response to detecting the one or more defects within the image data of the three-dimensional printed construct.

8. A system for detecting defects in three-dimensional printed constructs, the system comprising:
one or more processors;
a three-dimensional printer comprising an enclosure;
one or more image sensors positioned within the enclosure and communicatively coupled to the one or more processors;
one or more memory modules communicatively coupled to the one or more processors; and
machine-readable instructions stored on the one or more memory modules that, when executed by the one or more processors, cause the system to:
collect image data of a three-dimensional printed construct from the one or more image sensors; and
detect one or more defects within the image data of the three-dimensional printed construct.

9. The system of claim 8, the system further comprises one or more user interface devices communicatively coupled to the one or more processors, wherein the machine readable instructions, when executed by the one or more processors, further cause the system to output an alert with the one or more user interface devices in response to detecting the one or more defects within the image data of the three-dimensional printed construct.

10. The system of claim 8, wherein the machine readable instructions, when executed by the one or more processors, further cause the system to adjust operating parameters of the three-dimensional printer in response to detecting the one or more defects within the image data of the three-dimensional printed construct.

11. The system of claim 8, wherein the machine-readable instructions when executed by the one or more processors, further cause the system to abort completion of the three-dimensional printed construct.

12. The system of claim 8, wherein the image data is collected in real time as the three-dimensional printed construct is printed based on the one or more defects detected.

13. The system of claim 8, wherein the one or more defects include at least one of air bubbles, poor layer adhesion, material peaking, material collecting on a dispensing nozzle of the three-dimensional printer, nozzle scraping, material bulging, material curling, improper extrusion location, or any combination thereof.

14. The system of claim 8, further comprising network interface hardware communicatively coupled to the one or more processors, wherein the machine readable instructions, when executed by the one or more processors, further cause the system to output an alert with the network interface hardware to a mobile user device of a user in response to detecting the one or more defects within the image data of the three-dimensional printed construct.

15. A method for detecting defects in three-dimensional printed constructs, the method comprising:
receiving image data of a three-dimensional printed construct from one or more image sensors; and
processing the image data with one or more processors to detect one or more defects within the image data of the three-dimensional printed construct.

16. The method of claim 15, further comprising:
communicating an alert via one or more user interface devices in response to detecting the one or more defects within the image data of the three-dimensional printed construct.

17. The method of claim 15, further comprising:
automatically adjusting operating parameters of a three-dimensional printer in response to detecting the one or more defects within the image data of the three-dimensional printed construct.

18. The method of claim 15, further comprising:
automatically aborting completion of the three-dimensional printed construct based on the one or more defects detected.

19. The method of claim 15, wherein image data is collected an processed in real-time printing of the three-dimensional printed construct.

20. The method of claim 15, wherein the one or more defects include at least one of air bubbles, poor layer adhesion, material peaking, material collecting on a dispensing nozzle of a three-dimensional printer, nozzle scraping, material bulging, material curling, improper extrusion location, or any combination thereof.
